(19) United States
(12) Patent Application Publication
(10) Pub. No.: US 2026/0312076 A1
(43) Pub. Date: Oct. 8, 2026

(54) MULTI-METALLIC OXYGEN REDUCTION REACTION (ORR) Cu-Pt-Au CATALYST IN HIGH-TEMPERATURE PROTON EXCHANGE MEMBRANE FUEL CELLS

(71) Applicant: Toyota Motor Engineering & Manufacturing North America, Inc., Plano, TX (US)

(72) Inventors: Honghong Lin, Ann Arbor, MI (US); Shouheng Sun, East Greenwich, RI (US); Yuliang Chen, Providence, RI (US); Siwen Wang, Livonia, MI (US); Chen Ling, Troy, MI (US); Gaohua Zhu, Ann Arbor, MI (US)

(73) Assignees: Toyota Motor Engineering & Manufacturing North America, Inc., Plano, TX (US); Toyota Jidosha Kabushiki Kaisha, Aichi-ken (JP); Brown University, Providence, RI (US)

(21) Appl. No.: 19/170,793

(22) Filed: Apr. 4, 2025

(51) Int. Cl. H01M 4/86; H01M 4/92; H01M 8/10; H01M 8/1004

(52) U.S. Cl. CPC H01M 4/8657; H01M 4/8668; H01M 4/921; H01M 8/1004; H01M 2008/1095

(57) ABSTRACT

The present disclosure relates to high-temperature proton exchange membrane fuel cells (HT-PEMFCs) having phosphoric acid as a proton conductor comprising an anode, a cathode, and a proton exchange membrane (PEM) disposed between the anode and the cathode; and at least one catalyst layer disposed on the proton exchange membrane (PEM). The at least one catalyst layer comprises multi-metallic Cu—Pt—Au alloy catalyst nanoparticles comprising from about 5 to about 30 at % gold (Au), from about 5 to about 50 at % copper (Cu), and from about 30 to about 90 at % platinum (Pt).

### TECHNICAL FIELD

The present disclosure generally relates to high-temperature proton exchange membrane fuel cells (HT-PEMFCs) having phosphoric acid as a proton conductor and comprising a multi-metallic catalyst for oxygen reduction reactions (ORR).

### BACKGROUND

The background description provided herein is for the purpose of generally presenting the context of the disclosure. Work of the presently named inventors, to the extent it may be described in this background section, as well as aspects of the description that may not otherwise qualify as prior art at the time of filing, are neither expressly not implicitly admitted as prior art against the present technology.

Fuel cell vehicles (FCVs) are considered to be more efficient than conventional internal combustion engine vehicles. Current commercially available fuel cell vehicles use polymer electrolyte membrane fuel cells (PEMFCs), which have attracted attention as an energy source for transportation instead of conventional internal combustion engines because they have a high-power density, operate at low temperatures, and have zero emission of harmful gases.

Heavy duty vehicles (HDVs) generate more waste and require a higher temperature (>120° C.) compared to light-duty vehicles (LDVs) to meet the automotive heat rejection constraint. One of the major challenges for applying proton exchange membrane fuel cells (PEMFCs) to heavy-duty applications (e.g., class 8 trucks) is the heat dissipation limitation. Low-temperature proton exchange membrane fuel cells (LT-PEMFCs) that typically operate between 60° C.-80° C. make them unfavorable to be used for heavy-duty applications because of the need for a larger heat radiator for waste heat rejection of the low-temperature difference between the fuel cell and the environment. LT-PEMFCs generally employ a proton exchange membrane that conducts proton when the membrane is properly hydrated by water. The typical commercialized membrane is perfluorinated sulfonic-acid (PFSA). The PFSA relies on water to conduct protons so that the LT-PEMFCs can be functional. Anhydride PFSA does not conduct protons. Moreover, due to the thermal stability limitation of PFSA polymer, the LT-PEMFCs are usually not stable when operating above 120° C. (glass transition temperature of PFSA).

In order to improve the heat rejection of fuel cell stacks, fuel cells that operate at higher temperatures are preferred for heavy-duty applications where high-power output leads to high waste heat generation. For HT-PEMFCs that can operate above 110° C., preferably above 140° C. and ideally between 160° C.-200° C., water cannot be used for humidifying the proton conductor (electrolyte, typically PFSA) because of the low boiling point (100° C.). A thermally stable proton conductor has to be used for such high temperatures (120° C.-200° C.). Phosphoric acid (PA) is thermally stable at this temperature range and is a good proton conductor below 200° C. Above 200° C., phosphoric acid suffers from anhydride formation and evaporation.

Several efforts have been made to use phosphoric acid as the proton conductor both in the membrane and electrode of PEMFCs. In fuel cells employing phosphoric acid as the proton conductor in the membrane electrode assembly (MEAs), a major issue is the poisoning of the oxygen reduction reaction catalyst (typically a platinum (Pt) containing catalyst). The phosphate anion from phosphoric acid adsorbs on Pt catalyst surface and reduces electrochemical surface area (ECSA) and the ability of Pt catalyst to bond with oxygen reduction reaction (ORR) intermediates for electrochemically catalyzing oxygen to form water. Some efforts to address the problem of phosphate poisoning in high-temperature proton exchange membrane fuel cells (HT-PEMFCs) have been to design phosphate-tolerant catalyst materials, phosphate-tolerant supports, and/or polymer exchange membranes that retain phosphoric acid. There is still a desire to develop strategies and materials to mitigate phosphate poisoning in HT-PEMFCs to maintain efficiency and longevity.

### SUMMARY

This section provides a general summary of the disclosure and is not a comprehensive disclosure of its full scope or all of its features.

In various aspects, the present teachings provide a proton exchange membrane fuel cell (PEMFC) comprising: an anode, a cathode, and a proton exchange membrane (PEM) disposed between the anode and the cathode; and at least one catalyst layer disposed on the proton exchange membrane (PEM).

The at least one catalyst layer comprises multi-metallic Cu—Pt—Au alloy catalyst nanoparticles comprising from about 5 to about 50 at % copper (Cu), from about 30 to about 90 at % platinum (Pt), and from about 5 to about 30 at % gold (Au). In some examples, gold (Au) is about 6 at %. In other examples, gold (Au) is about 12 at %.

In some examples, the at least one catalyst layer further comprises at least one polymeric ionomer. In some examples the at least one catalyst layer is disposed on the cathode of the proton exchange membrane (PEM).

In some examples of the present disclosure, the proton exchange membrane fuel cell (PEMFC) is a high-temperature proton exchange membrane fuel cell (HT-PEMFC). The high-temperature proton exchange membrane fuel cell (HT-PEMFC) may comprise phosphoric acid or phosphonated ionomers as a proton conductor or a catalyst binder. The proton exchange membrane and/or the at least one polymeric ionomer layer may be selected from phosphoric acid doped polybenzimidazole (PA/PBI), quaternary ammonium phosphate ion pair polymers, polyvinylphosphonic acid (PVPA), sulfonated polyether ether ketone (SPEEK), poly(arylene ether sulfone) (PAES), sulfonated polyimides, perfluorosulfonic acid (PFSA) polyvinylidene fluoride (PVDF) copolymers, and combinations thereof.

The multi-metallic Cu—Pt—Au alloy catalyst nanoparticles may have a diameter of about 2 to about 20 nm and/or may comprise nanostructures selected from nanorods, nanowires, nanoframes, nanoplates, nanodisks, and nanosheets. In some examples, the multi-metallic catalyst nanoparticles have a core-shell structure wherein the core is surrounded by a Cu—Pt—Au shell. The shell of the multi-metallic catalyst nanoparticles may have a thickness of less than 10 nm and the core of the multi-metallic catalyst nanoparticles has a diameter of about 1 to about 20 nm. The core of the multi-metallic catalyst nanoparticles may be selected from a platinum (Pt)-containing core, a palladium (Pd)-containing core and a palladium/platinum (Pd/Pt)-containing core. In some examples, the core of the multi-metallic catalyst nanoparticles may be selected from palladium (Pd), platinum (Pt), a pallidium-containing alloy (PdM), a platinum-containing alloy (PtM), and a palladium/platinum alloy (PdPtM), wherein M is a metal selected from scandium (Sc), titanium (Ti), vanadium (V), chromium (Cr), manganese (Mn), iron (Fe), cobalt (Co), nickel (Ni), copper (Cu), zinc (Zn), yttrium (Y), ruthenium (Ru), silver (Ag), and iridium (Ir).

In other aspects, the present teachings of the present disclosure provide a membrane electrode assembly (MEA) for a high-temperature proton exchange membrane fuel cell comprising phosphoric acid or phosphonated ionomers as a proton conductor or a catalyst binder. The MEA comprises a proton exchange membrane (PEM); and at least one catalyst layer which contacts the proton exchange membrane (PEM), and wherein the catalyst layer comprises Cu—Pt—Au alloy catalyst nanoparticles comprising from about 5 to about 30 at % gold (Au), from about 5 to about 50 at % copper (Cu), and from about 30 to about 90 at % platinum (Pt). In some examples, gold (Au) is about 6 at %. In other examples, gold (Au) is about 12 at %. In some examples, the catalyst layer further comprises at least one polymeric ionomer. In some examples the at least one catalyst layer is disposed on the cathode of the proton exchange membrane (PEM).

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings wherein:

FIG. 1A is an illustration of the structure of a proton exchange membrane fuel cell (PEMFC) 100.

FIG. 1B is an illustration of an enlarged view of an interface section labeled 1B in 1A.

FIG. 1C is an illustration of an enlarged view of a metal catalyst nanoparticle in the interface in FIG. 1B.

FIG. 2 is an illustration of a membrane electrode assembly (MEA) 110.

FIG. 3A is a schematic illustration of the atomic structure of the multi-metallic Cu—Pt—Au alloy catalyst nanoparticles of the present disclosure having a core-shell structure.

FIG. 3B is a schematic illustration of the atomic structure of the multi-metallic Cu—Pt—Au alloy catalyst nanoparticles of the present disclosure having a core-shell structure with a nanorod or nanowire nanostructure.

FIG. 3C is a schematic illustration of the atomic structure of the multi-metallic Cu—Pt—Au alloy catalyst nanoparticles of the present disclosure having a core-shell structure with a nanodisk, nano plate, or nanosheet nanostructure.

FIG. 4A is a graphical illustration of the linear sweep voltammetry (LSV) curves comparing the oxygen reduction reaction (ORR) activity of different catalysts, including platinum (Pt), copper-platinum (CuPt), copper-platinum-gold (Cu—Pt—Au) with 6 at % Au, and copper-platinum-gold (Cu—Pt—Au) with 12 at % Au, in 0.1 M HClO₄ (perchloric acid) without phosphate ions. The polarization curves are plotted as current density (j) in milliamperes per square centimeter (mA/cm²) versus potential (E) in volts (V) relative to the reversible hydrogen electrode (RHE).

FIG. 4B is a graphical illustration of the linear sweep voltammetry (LSV) curves comparing the oxygen reduction reaction (ORR) activity of different catalysts, including gold-copper-platinum (Cu—Pt—Au) with 6 at % Au, copper-platinum-gold (Cu—Pt—Au) with 12 at % Au, copper-platinum (CuPt), and platinum (Pt), in 0.1 M HClO₄ (perchloric acid)+0.1 M H₃PO₄ (phosphoric acid), which contains phosphate ions. The polarization curves are plotted as current density (j) in milliamperes per square centimeter (mA/cm²) versus potential (E) in volts (V) relative to the reversible hydrogen electrode (RHE).

It should be noted that the figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific embodiments within the scope of this technology. Further, certain aspects may incorporate features from a combination of figures.

### DETAILED DESCRIPTION

The present disclosure provides a multi-metallic alloy catalyst designed for oxygen reduction reactions (ORR) in high-temperature proton exchange membrane fuel cells (HT-PEMFC) that employ phosphoric acid or phosphonated ionomers as the proton conductor or a catalyst binder. The multi-metallic alloy catalyst nanoparticles of the present disclosure can be used in such high temperature proton exchange membrane fuel cells (HT-PEMC) fueled by hydrogen for mitigating phosphate poisoning of the catalyst in the membrane electrode assembly (MEA). For purposes of this disclosure, “mitigating” refers to reducing and/or alleviating, the negative effects of phosphate ions on the electrochemical performance of a fuel cell. The multi-metallic alloy catalyst of the present disclosure provides enhanced resistance against acid poisoning and higher ORR activity in phosphoric acid as compared to commercial platinum-containing catalysts and bimetallic alloy catalysts.

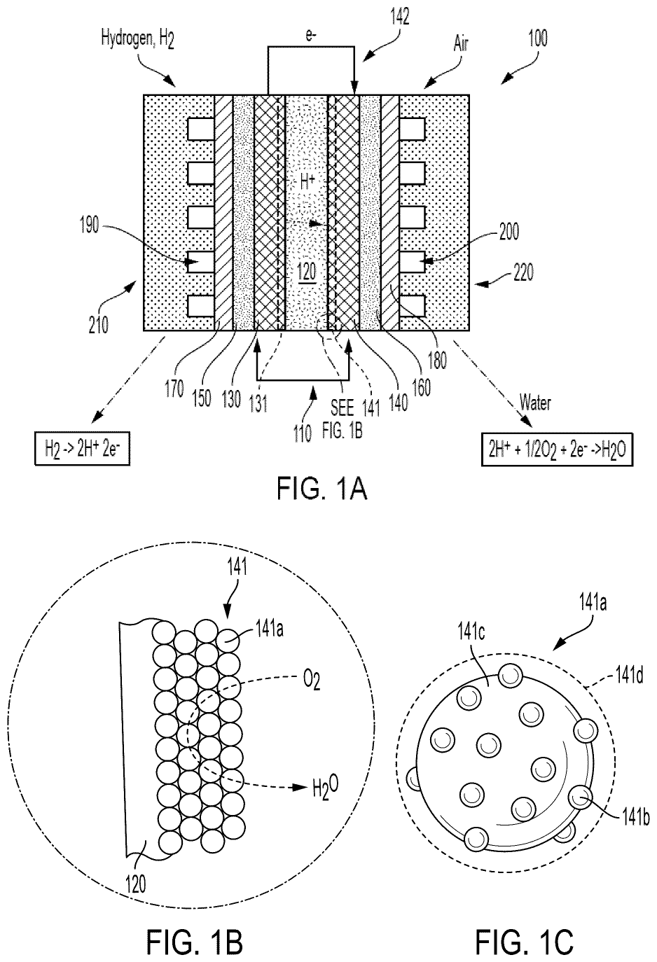

FIGS. 1A-1C illustrate the components and operation of a PEMFC 100, including both low-temperature proton exchange membrane fuel cells (LT-PEMFCs) and high-temperature proton exchange membrane fuel cells (HT-PEMFCs). For purposes of this disclosure, the terms “proton exchange membrane fuel cell”, “polymer exchange membrane fuel cell”, and “polymer electrolyte membrane fuel cell” may be used interchangeably to refer to PEMFCs generally. The PEMFC 100 includes a membrane-electrode assembly (MEA) 110, which comprises a proton exchange membrane (PEM) 120, positioned between an anode 130 and a cathode 140, and an external electrical circuit 142 that electrically connects the anode 130 and the cathode 140. A first microporous layer 150 (also referred to herein as an “anodic microporous layer” (AMPL)) contacts the anode 130. An anode gas diffusion layer (AGDL) 170 contacts the first microporous layer 150 and a first flow channel 190 contacts the anode gas diffusion layer 170. A second microporous layer (also referred to herein as a “cathodic microporous layer” (CMPL) 160 contacts the cathode 140. A cathode gas diffusion layer (CGDL) 180 contacts the second microporous layer 160 and a second flow channel 200 contacts the cathode gas diffusion layer 180. An anode bipolar plate 210 may contact the first flow channel 190 and a cathode bipolar plate 220 may contact the second flow channel 200.

The fuel gas is typically hydrogen. The hydrogen gas may be stored in a storage tank. Optionally, hydrogen may be stored as metal hydrides or may be hydrogen obtained by reforming a hydrocarbon fuel. The oxidizing gas is typically an oxygen-containing gas. In some embodiments, the oxidizing gas is ambient air. Hydrogen and air flow within the cell are illustrated in FIG. 1A. Hydrogen (H₂) is fed to the anode side of the fuel cell and an oxygen source (such as ambient air) is fed to the cathode side of the fuel cell. At least a portion of the H₂ flows into contact with the anode 130 and migrates to the PEM 120 where H₂ molecules are catalyzed into H⁺ ions plus electrons ‘e−’ (e.g., via an anode catalyst layer 131). Also, at least a portion of the O₂ gas flows into contact with the cathode 140 and migrates to the PEM 120. The electrons e− flow through the external electrical circuit 142 to the anode 130 and react with O₂ molecules to form O₂-ions (e.g., via the cathode catalyst layer 141) and the H⁺ ions diffuse through the PEM 120 to the cathode 140 and react with the O₂-ions to form H₂O (water), which is then transported out of the PEMFC 100 with the flow of unreacted O₂. In this manner, the Pt-containing nanoparticles assist in and enhance the reaction of O₂+e− to O₂₋ and/or O₂₋+H⁺ to H₂O and electricity is generated by the PEMFC 100. In FIG. 1A, water and excess air are depicted as exiting the cathode side of the fuel cell, and unreacted hydrogen is shown as exiting the anode side of the fuel cell.

The anode bipolar plate 280 and the cathode bipolar plate 290 can independently be made from a metal (such as titanium or stainless steel), or a carbon structure (such as graphite). Some metal bipolar plates use a carbon film coating on some or all surfaces of the bipolar plate. U.S. Pat. No. 10,283,785, incorporated herein by reference, teaches use of an amorphous carbon film in bipolar plates. In the fuel cell, the fuel gas and the oxygen gas should be separately supplied to the entire electrode surfaces without being mixed with each other. Therefore, the bipolar plates should be gas tight. Furthermore, the bipolar plates should collect electrons generated by the reaction and have good electric conductivity in order to serve as electric connectors for connecting adjoining single cells when a plurality of single cells are stacked. Moreover, because proton exchange membrane surfaces are strongly acidic, the bipolar plates provide good corrosion resistance. The main purpose of the bipolar plate in the PEMFC stack is to supply fuel (hydrogen) and oxygen to the cell and also to manage heat produced and water flow. It is also used as a backing medium for stacking individual fuel cells.

The cathode 140 includes a catalyst layer 141 with a plurality of composite multi-metallic alloy catalyst nanoparticles 141a as illustrated in FIG. 1B, and the composite nanoparticles 141a include a plurality of Pt-containing nanoparticles 141b which may be supported on the surface of carbon particles 141c as illustrated in FIG. 1C (only one carbon particle 141c shown). Referring specifically to FIG. 1C, in some examples an ionomer 141d from the PEM 120 is in contact with and at least partially surrounds the composite particles 141a. And in such examples, the ionomer 141d can poison the plurality of Pt-containing nanoparticles 141b (also known as “ionomer poisoning”) such that the efficiency of the catalyst layer 141 decreases. In addition, the plurality of Pt-containing nanoparticles 141b supported on an outer surface of the carbon particle 141c can agglomerate and/or increase in size such that an average effective size of the Pt-containing nanoparticles increases and the efficiency of the catalyst layer 432 decreases.

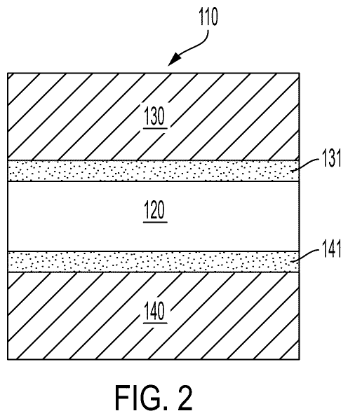

FIG. 2 is a schematic illustration of a membrane-electrode assembly (MEA) 110 comprising a proton exchange membrane 120, an anode 130, and a cathode 140. The anode 130 comprises an anodic catalyst layer 131, configured to electrolytically catalyze an anodic hydrogen-splitting reaction: H₂→2e⁻+2H⁺. The cathode 140 comprises a catalyst layer 141, which may be cathodic, configured to catalyze an oxygen reduction reaction: O₂+4e⁻+4H⁺→2H₂O.

Platinum is widely used as a cathode catalyst in electrochemical reactions, such as in fuel cells, because of its exceptional ability to speed up the oxygen reduction reaction (ORR). Platinum acts as an efficient catalyst during the electrochemical reduction of oxygen in a PEMFC by lowering the activation energy, stabilizing intermediates, and steering the ORR towards a more efficient and desired chemical pathway, thus significantly enhancing the overall reaction kinetics and thermodynamics on the Pt (111) surface. Platinum provides a surface that facilitates the transfer of electrons and protons to the adsorbed oxygen species, progressively reducing and splitting the molecule. The presence of platinum ensures that the reaction follows the four-electron pathway directly to water. The lowest energy state is reached with the formation of two (2) water molecules indicating this as the most stable product of the reaction pathway on Pt (111).

Platinum's unique surface properties not only adsorb and activate the reactants but also stabilize the intermediate reaction species, allowing controlled and sequential reaction steps. Previous approaches to producing catalyst particles with a higher catalytic activity and reduced loading of costly precious metals have typically involved the use of one or more components that are susceptible to corrosion in alkaline or acidic environments such as PtM, where M is a transition metal such as Ni, Co, Cu, or Fe. Over time, the gradual loss of these elements and their subsequent buildup in other critical components present within the energy conversion device, e.g., a proton exchange or electrolyte membrane, reduces both the activity level of the catalyst particles and the overall efficiency of the device.

LT-PEMFCs generally employ a proton exchange membrane that conducts protons when the membrane is properly hydrated by water. A typical commercialized membrane is perfluorinated sulfonic-acid (PFSA) having the following chemical structure:

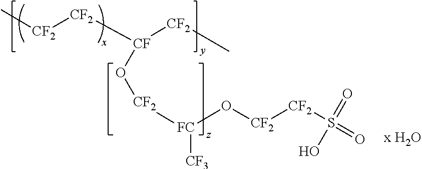

wherein x is 6.5-13.5; y is 200-1000, and z is 1. The PFSA relies on water to conduct protons so that the LT-PEMFCs can be functional. Anhydride PFSA does not conduct protons. Moreover, due to the thermal stability limitation of PFSA polymer, the LT-PEMFCs are usually not stable when operating above 120° C. (glass transition temperature of PFSA).

For HT-PEMFCs that can operate above 110° C., preferably above 140° C. and ideally between 160° C.-200° C., water cannot be used for humidifying the proton conductor (electrolyte, typically PFSA) because of the low boiling point (100° C.). A thermally stable proton conductor has to be used for such high temperatures (120° C.-200° C.). Phosphoric acid (PA) is thermally stable at this temperature range and is a good proton conductor below 200° C. Above 200° C., phosphoric acid suffers from anhydride formation and evaporation. One major issue with using phosphoric acid (PA) as the proton conductor is poisoning of the oxygen reduction reaction catalyst (typically Pt catalyst). The phosphate anion from phosphoric acid adsorbs on Pt catalyst surface, blocking active sites, and reduces electrochemical surface area (ECSA) and the ability of Pt catalyst to bond with oxygen reduction reaction (ORR) intermediates for electrochemically catalyzing oxygen to form water. Higher concentrations of phosphoric acid from phosphate poisoning result in lower current densities which hinders the overall electrochemical process. Phosphoric acid adsorption onto platinum decreases the number of surface reactive sites for oxygen reduction reaction (ORR), which limits the performance of high temperature proton exchange membrane fuel cells (HT-PEMFCs) (operation temperature >120° C.).

Oxygen reduction reactions (ORR), also known as redox reactions, are central to converting chemical energy into electrical energy. These reactions occur at two electrode layers, the anode and the cathode, separated by a proton exchange membrane. During fuel cell operation, the anode is supplied with hydrogen as a fuel and oxygen as an oxidant to the cathode. Then, fuel is oxidized to protons at the anode, and oxygen is reduced to water at the cathode to generate electricity.

Platinum catalysts are used in both the anode and cathode layers to facilitate the ORR reaction and to provide chemical stability, corrosion resistance, and durability to the fuel cell. Because the oxygen reduction reaction on the platinum containing catalysts is sluggish, a large amount of the platinum is needed to accelerate the reaction. Thus, the catalyst at the cathode is a main factor that determines the power generation characteristics of the PEMFC, and improving its ORR activity and performance is an important issue. In the past, bimetallic alloy catalysts were used as ORR catalysts in HT-PEMFCs. (Seselj, N. et al. Catalyst Development for High-Temperature Polymer Electrolyte Membrane Fuel Cell (HT-PEMFC) Applications. Advanced Materials (2023) doi:10.1002/adma.202302207.)

The present disclosure provides a proton exchange membrane fuel cell (PEMFC) comprising an anode, a cathode, and a proton exchange membrane (PEM) disposed between the anode and the cathode; and at least one catalyst layer contacting the proton exchange membrane (PEM). In examples of the present disclosure, the proton exchange membrane fuel cell (PEMFC) is a high-temperature proton exchange membrane fuel cell (HT-PEMFC). In some examples, the proton exchange membrane fuel cell (PEMFC) is a high-temperature proton exchange membrane fuel cell (HT-PEMFC), which comprises phosphoric acid or phosphonated ionomers as a proton conductor or a catalyst binder. The proton exchange membrane fuel cell (PEMFC) may further comprise at least one polymeric ionomer which may serve as a proton conductor and/or a catalyst binder.

The present disclosure provides a high-temperature proton exchange membrane fuel cell (HT-PEMFC) electrode structure for HT-PEMFCs that employ phosphoric acid as the proton conductor and a method for mitigating phosphate poisoning of the catalyst in the membrane electrode assembly (MEA). The membrane electrode assembly (MEA) of the present disclosure comprises at least one electrode comprising phosphoric acid (PA) as a proton conductor; a proton exchange membrane; and at least one catalyst layer which comprises multi-metallic alloy catalyst nanoparticles. The MEA may further comprise at least one polymeric ionomer layer.

The proton exchange membrane and the polymeric ionomer layer comprise specialized polymer materials having proton conductivity and thermal stability, which are advantageous for use in HT-PEMFCs. Suitable polymers for the proton exchange membrane and/or polymeric ionomer layer of the present disclosure include but are not limited to, phosphoric acid doped polybenzimidazole (PA/PBI), quaternary ammonium phosphate ion pair polymers, polyvinylphosphonic acid (PVPA), sulfonated polyether ether ketone (SPEEK), poly(arylene ether sulfone) (PAES), sulfonated polyimides, perfluorosulfonic acid (PFSA) polyvinylidene fluoride (PVDF) copolymers, and combinations thereof. The polymers may be blended or used to compose composite membranes. In some examples of the present disclosure the proton exchange membrane and/or polymeric ionomer layer comprises a phosphoric acid doped quaternary ammonium biphosphate ion pair coordinated polyphenylene (PA-QAPOH).

The PEMFC of the present disclosure comprises multi-metallic alloy catalyst nanoparticles having high ORR activity in an acid environment such as phosphoric acid, and enhanced resistance against acid poisoning. The multi-metallic alloy catalyst material of the present disclosure comprises trimetallic gold-copper-platinum (Cu—Pt—Au) alloy catalyst nanoparticles. The multi-metallic Cu—Pt—Au alloy catalyst nanoparticles comprising from about 5 to about 30 at % gold (Au), from about 5 to about 50 at % copper (Cu), and from about 30 to about 90 at % platinum (Pt). The oxygen reduction reaction (ORR) occurs at surface reactive sites of platinum (Pt). If the Pt at % is too low, the ORR activity of the catalyst may be compromised. Copper (Cu) and the at % contribute to alloy formation, retaining active platinum (Pt) site and desired catalytic properties for oxygen reduction reactions. If the at % of copper (Cu) is too low, poor oxygen binding can occur leading to slower reaction rates. If the at % of copper (Cu) is too high, platinum (Pt) activity can be reduced. Gold (Au), and the range of the at % of gold (Au) in the trimetallic alloy catalyst nanoparticles of the present disclosure has been found by the present inventors to contribute to enhancing the ORR activity in phosphoric acid. The present inventors have found that a small amount of gold (Au), about 6 at % helps to improve ORR performance in acidic environments such as in perchloric acid (HClO₄) as compared to commercial platinum catalysts and bimetallic catalysts. The present inventors further found that a higher gold (Au) content of about 12 at % helps to alleviate the adverse effects of phosphate ions in ORR, thereby mitigating phosphate poisoning as compared to commercial platinum catalysts and bimetallic catalysts.

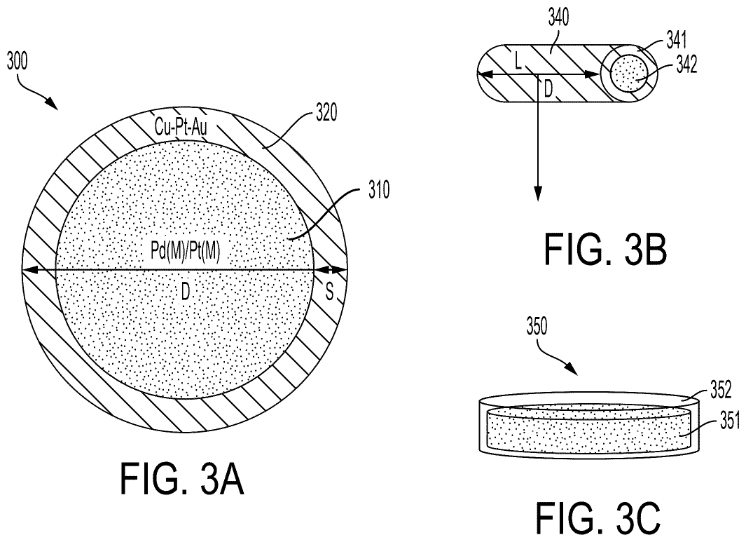

As illustrated in FIG. 3A, the multi-metallic Cu—Pt—Au alloy catalyst nanoparticles 300 may have a core-shell structure wherein the core 310 is surrounded by a Cu—Pt—Au shell 320. The multi-metallic Cu—Pt—Au alloy catalyst nanoparticles 300 of the present disclosure have a particle diameter D of about 2 to 20 nm. The Cu—Pt—Au shell portion of the core-shell structure has a thickness S of less than 10 nm. In some examples the thickness S of the shell is between about 0.3 to about 10 nm.

The size and shape of the catalytic metal particles can be optimized to maximize the total surface area of the catalyst and reaction sites available to participate in the reactions per volume of catalyst used. The multi-metallic Cu—Pt—Au alloy catalyst nanoparticles 300 of the present disclosure may comprise various nanostructures classified as zero-dimensional (0D), one-dimensional (1D), or two-dimensional (2D). Examples of zero-dimensional (0D) nanostructures, include but are not limited to, spherical (i.e., round) and spheroidal (i.e., elongated). Examples of one-dimensional (1D) nanostructures, include but are not limited to, nanorods (i.e., short cylindrical structures), nanowires (i.e., thin fibers), and the like. Examples of two-dimensional (2D) nanostructures, include but are not limited to, nanoplates (i.e., flat-plate-like), nanodisks (i.e., disk-shaped), nanosheets (i.e., thin layers), and the like. The multi-metallic Cu—Pt—Au alloy catalyst nanoparticles may also comprise nanoframes (i.e., hollow skeletal structures) and other nanostructures. FIG. 3B illustrates nanorods 340, as an example of a nanostructure of the multi-metallic Cu—Pt—Au alloy catalyst nanoparticles 300 of the present disclosure, having a rod-shaped core 341, a diameter D between 1-20 nm, length L between 1 nm-1 μm, and are surrounded or encapsulated by the Cu—Pt—Au alloy shell 342 having a thickness between 0.3-10 nm. FIG. 3C illustrates nanodisks 350, another example of the nanostructures of multi-metallic Cu—Pt—Au alloy catalyst nanoparticles of the present disclosure having a disk-shaped core 351, a diameter D between 1 nm-1μ, thickness T between 0.3-5 nm, surrounded or encapsulated by the Cu—Pt—Au alloy shell 352 having a thickness between 0.3-10 nm. In some examples, the particles of a catalytic metal may have a specific surface area of at least 10 m²/g, or 20 m²/g, or 30 m²/g, or 40 m²/g, or 50 m²/g, or 60 m²/g, or 70 m²/g, or 80 m²/g, or 90 m²/g, or 100 m²/g.

The core of the multi-metallic catalyst nanoparticles is selected from a platinum (Pt)-containing core, a palladium (Pd)-containing core and a palladium/platinum (Pd/Pt)-containing core. In some examples, the core of the multi-metallic catalyst nanoparticles is selected from palladium (Pd), platinum (Pt), a pallidium-containing alloy (PdM), a platinum-containing alloy (PtM), and a palladium/platinum alloy (PdPtM), wherein M is a metal selected from scandium (Sc), titanium (Ti), vanadium (V), chromium (Cr), manganese (Mn), iron (Fe), cobalt (Co), nickel (Ni), copper (Cu), zinc (Zn), yttrium (Y), ruthenium (Ru), silver (Ag), and iridium (Ir).

The proton exchange membrane and the polymeric ionomer layer may comprise specialized polymer materials having proton conductivity and thermal stability, which is advantageous for use in HT-PEMFCs. Suitable polymers for the proton exchange membrane and/or polymeric ionomer layer of the present disclosure include but are not limited to, phosphoric acid doped polybenzimidazole (PA/PBI), quaternary ammonium phosphate ion pair polymers, polyvinylphosphonic acid (PVPA), sulfonated polyether ether ketone (SPEEK), poly(arylene ether sulfone) (PAES), sulfonated polyimides, perfluorosulfonic acid (PFSA) polyvinylidene fluoride (PVDF) copolymers, and combinations thereof. The polymers may be blended or used to compose composite membranes.

The present disclosure also provides a membrane electrode assembly (MEA) for a high-temperature proton exchange membrane fuel cell comprising phosphoric acid as a proton conductor, wherein the membrane exchange assembly (MEA) comprises a proton exchange membrane; and at least one catalyst layer which contacts the proton exchange membrane (PEM). The catalyst layer contacting the PEM at the cathode side comprises Cu—Pt—Au alloy catalyst nanoparticles comprising from about 5 to about 30 at % gold (Au), from about 5 to about 50 at % copper (Cu), and from about 30 to about 90 at % platinum (Pt). In some examples, gold (Au) is about 6 at %. In some other examples gold (Au) is about 12 at %.

The catalyst layer of the MEA may further comprise at least one polymeric ionomer. Thus, the membrane electrode assembly (MEA) may comprise phosphoric acid or phosphonated ionomers as a proton conductor or a catalyst binder. The at least one catalyst layer is advantageously disposed on the cathode side or contacts the cathode of the of the proton exchange membrane (PEM).

The present disclosure is further directed to a high temperature proton exchange membrane fuel cells (HT-PEMFCs) with a cathode that includes a Cu—Pt—Au catalyst with composition within the range of (at %) Au: 5-30%, Cu: 5-50%, Pt: 30-90%. And in one example, the HT-PEMFC uses hydrogen as a fuel instead of methanol.

### EXAMPLES

Various aspects of the present disclosure are further illustrated with respect to the following examples. It is to be understood that these examples are provided to illustrate specific embodiments of the present disclosure and should not be construed as limiting the scope of the present disclosure in or to any particular aspect.

### Materials

Materials used include borane morpholine complex-oleylamine, oleylamine (70%), Cu(acac)₂, Pt(acac)₂ (Sigma Aldrich), HAuCl₄ (Strem Chemicals), 10% Nafion 212, and Ketjen 300J (Fuel Cell Store). All materials were used as received without further purification.

### Synthesis

### Example S1. Synthesis of CuPtAu Nanoparticles (NPs)

For the synthesis of CuPtAu NPs with different Au content (Cu₄₅Pt₅₀Au₅), 0.1 mmol of Pt(acac)₂, 0.09 mmol of Cu(acac)₂, and 0.01 mmol of HAuCl₄ were mixed in a 50 ml flask with 10 ml of oleylamine (70%). This mixture was pre-heated at 85° C. under Ar atmosphere for 30 mins, followed by quick injection of borane morpholine complex-oleylamine solution (200 mg in 3 ml). The temperature was then raised to 300° C. with a ramping rate of 15° C./mins and kept for 30 mins. After the mixture returned to room temperature, isopropanol was added to precipitate the NPs. The NPs were separated by centrifugation and washed by isopropanol/hexane (5:1) for three times. CuAuPt NPs were dispersed in hexane for further use.

### Example S2. Catalyst Preparation

25 mg of CuPtAu NPs were deposited onto 60 mg Ketjen 300J carbon to obtain the catalyst with Pt loading of ~20 wt % for electrochemical experiment. The catalyst ink was prepared by dispersing a certain amount of carbon-supported catalyst into a mixture solution of isopropanol/water (4:1, 1 ml in total) with 10% Nafion 212 solution added. 10 ul of ink were drop casted onto a glass carbon rotating electrode with a diameter of 5 mm to create a uniform film with Pt loading of 4 ug.

### Performance Evaluation

### Example 1. Electrochemical Measurement

For electrochemical measurement, a Pt wire was used as counter electrode while a non-leachable Ag/AgCl electrode was used as the reference electrode. The catalyst was first activated by cyclic voltammetry in 0.1 M HClO₄ solution saturated with N₂ within the potential range of 0.00-1.20 V for ~30 cycles. A stable CV curve was obtained from 0.00 V-1.20 V. The ECSA was calculated according to the hydrogen desorption area from 0.04 V-0.40 V. The ORR polarization curve was then measured in 0.1 M HClO₄ or 0.1 M HClO_{4+0.1} M H₃PO₄ solution saturated with O₂ at 1600 rpm, 25° C.

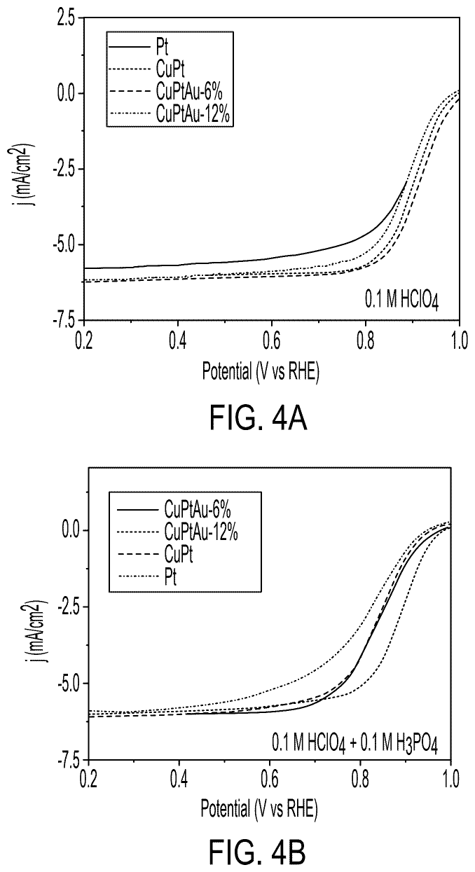

### Example 2: ORR Performance in 0.1 M HClO₄ Solution (FIG. 4A)

Samples of CuPt, CuPtAu-6 (6 at % Au), CuPtAu-12 (12 at % Au), and commercial Pt/C were tested in 0.1 M HClO₄ saturated with O₂ to evaluate their oxygen reduction reaction (ORR) performance. The results are presented in Table 1 and illustrated in FIG. 4A, which shows the polarization curves for each catalyst.

TABLE 1
ORR Performance in 0.1M HClO₄

| | | | Mass | Specific |
|---|---|---|---|---|
| | | Half-wave | Activity | Activity |
| | H Desorption | potential | 0.9 V | 0.9 V |
| Sample | (m²/g Pt) | (V) | (A/mg Pt) | (mA/cm² Pt) |
| CuPt | 66.2 | 0.902 | 0.43 | 0.65 |
| CuPtAu-6 | 62.8 | 0.913 | 0.58 | 0.93 |
| CuPtAu-12 | 64.9 | 0.885 | 0.19 | 0.29 |
| Comm. Pt/C | 95.3 | 0.885 | 0.19 | 0.2 |

As shown in FIG. 4A, the ORR performance of the catalysts in 0.1 M HClO₄ follows the trend: CuPtAu-6>CuPt>CuPtAu-12≈Pt. This indicates that CuPtAu-6 exhibited the highest ORR performance in 0.1 M HClO₄, as reflected by its highest half-wave potential (0.913 V) and the highest mass and specific activities. This suggests that a small amount of Au (~6 at %) enhances ORR performance in pure HClO₄. On the other hand, CuPtAu-12 and commercial Pt/C showed lower ORR activity, with similar half-wave potentials (0.885 V) and lower mass and specific activities.

### Example 3. ORR Performance in 0.1M HClO₄+H₃PO₄ (FIG. 4B)

To assess the effect of phosphate ions (H₃PO₄) on ORR activity, the same set of catalysts were tested in a mixed 0.1 M HClO_{4+0.1} M H₃PO₄ solution saturated with O₂. The results are presented in Table 2 and illustrated in FIG. 4B.

TABLE 2
ORR Performance in 0.1M HClO₄ + 0.1M H₃PO₄

| | Half-wave | Mass Activity at |
|---|---|---|
| Sample | Potential (V) | 0.9 V (A/mg Pt) |
| CuPt | 0.835 | 0.057 |
| CuPtAu-6 | 0.841 | 0.126 |
| CuPtAu-12 | 0.883 | 0.213 |
| Comm. Pt/C | 0.807 | 0.039 |

As shown in FIG. 4B, all catalysts exhibited a reduction in ORR performance, in the presence of phosphate ions, likely due to phosphate ion adsorption, which blocks active sites. However, the CuPtAu-12 catalyst exhibited the highest ORR activity, with a half-wave potential of 0.883 V and a mass activity of 0.213 A/mg Pt, outperforming all other catalysts. The performance ranking in HClO₄+H₃PO₄ follows the trend: CuPtAu-12>CuPtAu-6>CuPt>Pt. This indicates that while phosphate ions suppress ORR activity in all catalysts, the higher Au content (12 at %) significantly reduces the negative impact of phosphate poisoning, thereby maintaining better ORR activity.

Based on Examples 2 and 3, it can be seen that CuPtAu-6 demonstrated the best ORR activity in HClO₄ (FIG. 4A, Table 1), indicating that a small amount of Au (~6 at %) enhances catalytic performance. However, in HClO₄+H₃PO₄ (FIG. 4B, Table 2), where phosphate poisoning occurs, CuPtAu-12 showed the highest ORR activity, indicating that a higher Au content (12 at %) helps mitigate the detrimental effects of phosphate ions on ORR performance. This suggests that Au incorporation plays a critical role in tuning ORR activity, with lower Au content being advantageous in pure acidic environments and higher Au content being more beneficial in phosphate-containing conditions.

The multi-metallic Cu—Pt—Au alloy catalyst of the present disclosure comprising 5-30 at % Au, 6-50 at % Cu, and 30-90 at % Pt for high temperature proton exchange membrane fuels cells and methods for mitigating phosphoric acid poisoning can be applied to fuels cells that involve the use of phosphoric acid as a proton conductor in the membrane electrode assembly (MEAs) including, but not limited to phosphoric acid fuel cells (PAFCs), phosphoric acid doped polybenzimidazole (PA/PBI) membrane PEMFC (PA/PBI PEMFC) and HT-PEMFCs based on quaternary ammonium biphosphate ion-pair coordination (ion-pair HT-PEMFCs). Such fuel cells can be useful for stationary power generation for buildings and industrial applications, automotive applications such as high-efficiency, quick-start fuel cells for vehicles, and portable power devices requiring density and durability.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. A proton exchange membrane fuel cell (PEMFC) comprising:
an anode, a cathode, and a proton exchange membrane (PEM) disposed between the anode and the cathode; and
at least one catalyst layer disposed on the proton exchange membrane (PEM),
wherein the at least one catalyst layer comprises multi-metallic Cu—Pt—Au alloy catalyst nanoparticles comprising from about 5 to about 30 at % gold (Au), from about 5 to about 50 at % copper (Cu), and from about 30 to about 90 at % platinum (Pt).

2. The proton exchange membrane fuel cell (PEMFC) according to claim 1, wherein the at least one catalyst layer further comprises at least one polymeric ionomer.

3. The proton exchange membrane fuel cell (PEMFC) according to claim 1, which is a high-temperature proton exchange membrane fuel cell (HT-PEMFC).

4. The proton exchange membrane fuel cell (PEMFC) according to claim 3, wherein the high-temperature proton exchange membrane fuel cell (HT-PEMFC) comprises phosphoric acid or phosphonated ionomers as a proton conductor or a catalyst binder.

5. The proton exchange membrane fuel cell (PEMFC) according to claim 2, wherein the proton exchange membrane and/or the at least one polymeric ionomer layer comprises phosphoric acid doped polybenzimidazole (PA/PBI), quaternary ammonium phosphate ion pair polymers, polyvinylphosphonic acid (PVPA), sulfonated polyether ether ketone (SPEEK), poly(arylene ether sulfone) (PAES), sulfonated polyimides, perfluorosulfonic acid (PFSA) polyvinylidene fluoride (PVDF) copolymers, and combinations thereof.

6. The proton exchange membrane fuel cell (PEMFC) according to claim 1 wherein the at least one catalyst layer is disposed on the cathode of the proton exchange membrane (PEM).

7. The proton exchange membrane fuel cell (PEMFC) according to claim 1, wherein gold (Au) is about 6 at %.

8. The proton exchange membrane fuel cell (PEMFC) according to claim 1, wherein gold (Au) is about 12 at %.

9. The proton exchange membrane fuel cell (PEMFC) according to claim 1, wherein the multi-metallic Cu—Pt—Au alloy catalyst nanoparticles have a diameter of about 2 to about 20 nm.

10. The proton exchange membrane fuel cell (PEMFC) according to claim 1, wherein the multi-metallic alloy catalyst nanoparticles comprise nanostructures selected from nanorods, nanowires, nanoframes, nanoplates, nanodisks, and nanosheets.

11. The proton exchange membrane fuel cell (PEMFC) according to claim 1, wherein the multi-metallic catalyst nanoparticles have a core-shell structure wherein the core is surrounded by a Cu—Pt—Au shell.

12. The proton exchange membrane fuel cell (PEMFC) according to claim 11, wherein the shell of the multi-metallic catalyst nanoparticles has a thickness of less than 10 nm.

13. The proton exchange membrane fuel cell (PEMFC) according to claim 11, wherein the core of the multi-metallic catalyst nanoparticles has a diameter of about 1 to about 20 nm.

14. The proton exchange membrane fuel cell (PEMFC) according to claim 11, wherein the core of the multi-metallic catalyst nanoparticles is selected from a platinum (Pt)-containing core, a palladium (Pd)-containing core and a palladium/platinum (Pd/Pt)-containing core.

15. The proton exchange membrane fuel cell (PEMFC) according to claim 11, wherein the core of the multi-metallic catalyst nanoparticles is selected from palladium (Pd), platinum (Pt), a pallidium-containing alloy (PdM), a platinum-containing alloy (PtM), and a palladium/platinum alloy (PdPtM), wherein M is a metal selected from scandium (Sc), titanium (Ti), vanadium (V), chromium (Cr), manganese (Mn), iron (Fe), cobalt (Co), nickel (Ni), copper (Cu), zinc (Zn), yttrium (Y), ruthenium (Ru), silver (Ag), and iridium (Ir).

16. A membrane electrode assembly (MEA) for a high-temperature proton exchange membrane fuel cell comprising phosphoric acid or phosphonated ionomers as a proton conductor or a catalyst binder, said MEA comprising:
an anode and a cathode;
a proton exchange membrane (PEM) positioned between the anode and cathode; and
at least one catalyst layer which contacts the proton exchange membrane (PEM), and
wherein the catalyst layer comprises Cu—Pt—Au alloy catalyst nanoparticles comprising from about 5 to about 30 at % gold (Au), from about 5 to about 50 at % copper (Cu), and from about 30 to about 90 at % platinum (Pt).

17. The membrane electrode assembly (MEA) according to claim 16, wherein the catalyst layer further comprises at least one polymeric ionomer.

18. The membrane electrode assembly (MEA) according to claim 16, wherein the at least one catalyst layer is disposed on the cathode of the proton exchange membrane (PEM).

19. The membrane electrode assembly (MEA) according to claim 1, wherein gold (Au) is about 6 at %.

20. The membrane electrode assembly (MEA) according to claim 1, wherein gold (Au) is about 12 at %.
